(19) United States
(12) Patent Application Publication
(10) Pub. No.: US 2012/0267135 A1
(43) Pub. Date: Oct. 25, 2012

(54) Electric Power Tool with Ultrasonic Excitation

(75) Inventor: Jochen Roser, Leonberg-Gebersheim (DE)

(73) Assignee: Robert Bosch GmbH, Stuttgart (DE)

(21) Appl. No.: 13/502,705

(22) PCT Filed: Oct. 8, 2010
(86) PCT No.: PCT/EP2010/065112

§ 371 Date: Jul. 15, 2012

(30) Foreign Application Priority Data
Oct. 23, 2009 (DE) 102009045945.6

(51) Int. Cl. B23Q 17/00

(52) U.S. Cl. 173/20

(57) ABSTRACT

An electric power tool includes a region with ultrasonic excitation for a tool that can be driven in a linear and/or oscillating manner, with a drive unit for ultrasonic excitation, an electronics unit for applying at least controlling and/or regulating signals to the drive unit, as well as an operating voltage unit. The drive unit includes at least one ultrasonic excitation actuator, which during operation is electrically supplied by the operating voltage unit and is controlled and regulated by the electronics unit. A device is provided for outputting an information signal, which can be output on the basis of at least one operating parameter of the electric power tool. It is proposed that the device is formed for the purpose of varying frequency and/or amplitude of the information signal on the basis of one or more current operating parameters.

### PRIOR ART

The invention relates to an electric machine tool with ultrasonic excitation for a tool which can be driven linearly and/or in oscillating fashion.

DE 42 91 110 T1 discloses an ultrasonic cutter for removing plaster cast bandages and synthetic cast bandages on patients for treatment purposes or once healing is complete. In order to indicate the operating state of the ultrasonic cutter and as a warning that the cutting blade is in a cutting operating state, an acoustic signal transmitter is provided, which emits a buzzing signal on actuation of the switch.

### DISCLOSURE OF THE INVENTION

The invention is based on an electric machine tool comprising a region with ultrasonic excitation for a tool which can be driven linearly and/or in oscillating fashion, with a drive unit for ultrasonic excitation, an electronics unit for applying at least control and/or regulation signals to the drive unit, and an operating voltage unit, the drive unit comprising at least one ultrasonic excitation actuator, which, during operation, is supplied with electricity from the operating voltage unit and is subjected to control or regulation by the electronics unit, an apparatus being provided for outputting an information signal, which can be output depending on at least one operational parameter of the electric machine tool.

It is proposed that the apparatus is designed to vary the frequency and/or amplitude of the information signal depending on one or more present operational parameters. By virtue of the information signal, it is possible for feedback in respect of the system power or else in respect of other system parameters to be given to the user.

The electric machine tool operates substantially free of noise, with the result that the user can identify from the information signal whether the electric machine tool is in operation or not. The information signal is preferably output as long as the excitation actuator is in operation. The operational safety of the electric machine tool is increased. The information signal may be, for example, an audible tone, vibration which can be felt and/or a visible light. By virtue of the variable information signal, it is possible to communicate to the user a present operating state of the electric machine tool without said user being distracted from his actual machining activity with the electric machine tool. The user can be provided with information on a presently required ultrasonic power via the information signal, for example.

In this case, the tool can be an insert tool, which is detachably connected to the excitation actuator, or can be fixedly connected to the excitation actuator, for example cohesively or in a force-fitting manner. The electric machine tool is in particular a machining device with which articles or surfaces are machined or altered, such as drills, hammer drills, cutting tools, grinders, mills, saws, welding appliances or the like. The excitation actuator can form the single drive for the tool, or else it is possible for one or more further drive components, for example an electric motor, to be provided, with which the working movements can also overlap. The various drive components can be operated alternatively or in combination. The at least one excitation actuator can form a primary energy consumer of the electric machine tool, for which preferably at least 50% of the electrical input power can be intended. In a favorable development, at least 75%, preferably at least 80% of the electrical input power can be intended for the excitation actuator. The working progress of the electric machine tool when using ultrasound is particularly great, with the result that any further energy consumer which may be provided, in particular a further drive component, such as an electric machine, can be provided with a smaller configuration. Thus, the drive and the associated electronic components and the energy supply can also be smaller, which in turn provides the possibility of improved comfort during use and improved handling of the handheld electric machine tool.

The electric machine tool can be battery operated or else equipped with a mains cable in addition or as an alternative. The electric machine tool can comprise a plurality of parts, which are accommodated in separate housings, the user, for example, only holding the housing in which the actual tool region is arranged. Advantageously, the electric machine tool can be a handheld machine with a high operating power, in which all of the components are integrated in a single housing, with the result that a user can hold and guide the machine comfortably in his hand without being disrupted by any cable connections to a separate control device.

A particularly high mechanical output power with a sufficiently high magnification factor of the oscillating system corresponding to an electrical input power can be output when the excitation actuator can be operated at its resonant frequency. The excitation actuator can be in the form of, for example, a piezoelectric actuator with the design of a Langevin oscillator. The resonant system of the excitation actuator which has the resonant frequency comprises the Langevin oscillator with a piezoelectrically active material and components coupled to the oscillator, in particular components which intensify the ultrasound and/or transmit the ultrasound to a machining location. Such components are known as boosters or sonotrodes, for example. This makes it possible to reduce the physical size and to provide a compact appliance. Advantageously, a compact electric machine tool with a high performance which is at the same time wieldy is thus provided.

In accordance with an advantageous configuration of the invention, the apparatus can be designed to reduce the frequency and/or the amplitude of the information signal as the machining power increases. In the case of an audible information signal, a pattern of noises of a machine operated by an electric motor simulates a reduction in the frequency, for example starting from an idling fundamental tone. The audible information signal can also be varied in terms of its volume (via the amplitude). Alternatively, the apparatus can be designed to increase the frequency and/or the amplitude as the machining power increases. In any case, a present operating state of the electric machine tool can be communicated to the user by means of the information signal which is variable depending on the operating state without said user being distracted from his actual machining activity.

In accordance with an advantageous configuration of the invention, the apparatus for changing the frequency and/or the amplitude can be coupled to the operating voltage unit in such a way that the frequency and/or the amplitude can be set depending on the present operating current or on the present operating voltage. The operating current and the operating voltage are easily accessible and can advantageously be used for changing the information signal.

In accordance with an advantageous configuration of the invention, a first component of the information signal can be linked to a first operational parameter, and a second component of the information signal can be linked to a second operational parameter. It is thus possible, for example, for the frequency to be used as an indication of the required ultrasonic power and for the volume to be used as an indication of the excitation amplitude of the excitation actuator.

In accordance with an advantageous configuration of the invention, the apparatus can be designed to emit an alarm when a critical operational parameter is reached. Thus, the operating limit being reached or exceeded can be signaled. Other critical operational parameters can likewise be represented in this way, such as the event of a maximum permissible temperature level being reached, for example of the drive electronics or the excitation actuator; a minimum battery capacity being reached in the case of cable-less electric machine tools; machining of unsuitable materials; an incorrectly positioned sonotrode tool; other general system errors.

In accordance with an advantageous configuration of the invention, the apparatus can comprise a loudspeaker device, for example with a piezoelectric loudspeaker. A pleasant idling fundamental tone with a pleasant low volume can be output, and this can be changed in terms of frequency and/or power, for example corresponding to the presently required working power. As an alternative or in addition, in accordance with an advantageous configuration of the invention, the apparatus can comprise a mechanical vibration unit, preferably in a grip region of the housing. As an alternative or in addition, in accordance with a further advantageous configuration of the invention, the apparatus can comprise a luminaire unit. In this case, the color and/or luminous intensity can be varied. The luminaire unit can be provided to illuminate a working area. This can be seen by the user “out of the corner of his eye” without the user needing to especially read an indicator. The user can in each case keep the working area in his field of vision and is not distracted by looking at indicators or displays on the appliance.

In accordance with a further aspect of the invention, an ultrasonic stationary appliance is proposed which comprises an apparatus for outputting an information signal, which can be output depending on at least one operational parameter of the ultrasonic stationary appliance, the apparatus being designed to vary the frequency and/or amplitude of the information signal depending on a present operational parameter. Such ultrasonic stationary appliances can be, for example, ultrasonic welding appliances, ultrasonic cutters, ultrasonic screening systems, ultrasonic nebulizers or ultrasonic atomizers. In this case, too, the operational safety can be increased when the user is informed, by means of an information signal, of the fact that the appliance is in operation.

### DRAWING

Further advantages result from the description of the drawings below. In the drawing, exemplary embodiments of the invention are illustrated. The drawing, the description and the claims contain numerous features in combination. A person skilled in the art will expediently also consider the features individually and form sensible further combinations thereof.

In the drawing, by way of example:

FIG. 1 shows an exemplary embodiment of a handheld electric machine tool in a configuration as a cutter;

FIG. 2 shows a further exemplary embodiment of a handheld electric machine tool in a configuration as a drill;

FIG. 3 shows an electric machine tool in the form of an angle grinder, in section; and

FIG. 4 shows a circuit for generating an information signal.

### EMBODIMENTS OF THE INVENTION

Identical or similar components are denoted by the same reference symbols in the figures.

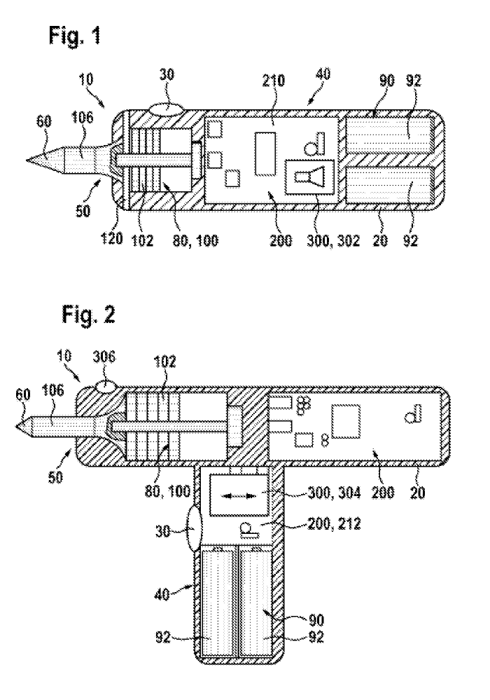

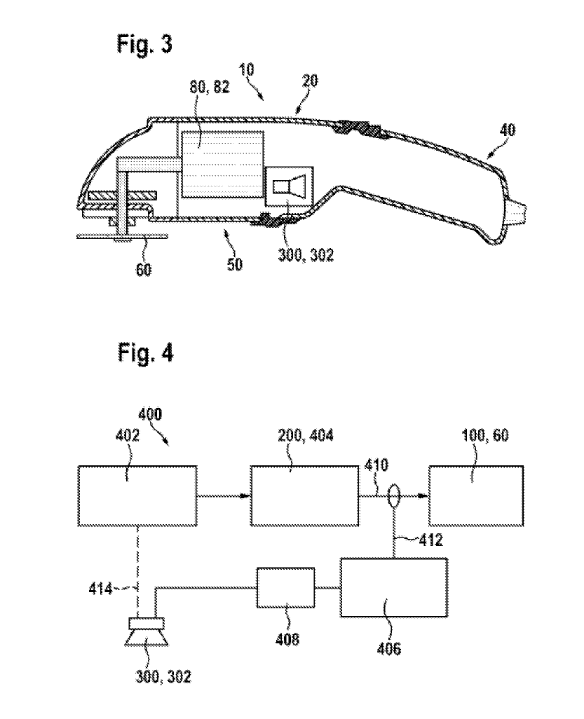

In order to explain the invention, FIGS. 1, 2 and 3 show different examples of handheld electric machine tools 10. FIG. 1 shows a cutter with an elongate housing form; FIG. 2 shows a drill with a T-shaped housing form, and FIG. 3 shows an angle grinder, in which a tool 60 in the form of a grinding disk is caused to oscillate at a high frequency, in addition to its rotary working movement.

The respective handheld electric machine tool 10 comprises a housing 20 with a grip region 40. A user holds the electric machine tool 10 in the grip region 40 and can guide the electric machine tool 10. The grip region 40 can, if appropriate, be decoupled from other housing regions by means of a damping element (not illustrated). The electric machine tool 10 further comprises a tool region 50 for a tool 60 which can be driven linearly and/or in oscillating fashion, for example a blade (FIG. 1) or a drill bit (FIG. 2), a grinding disk (FIG. 3) or another tool corresponding to a different type of appliance.

The respective electric machine tool 10 further comprises a region 50 with ultrasonic excitation for a tool 60 which can be driven linearly and/or in oscillating fashion, with a drive unit 80 for ultrasonic excitation, an electronics unit 200 for applying at least control and/or regulation signals to the drive unit 80 (not explicitly illustrated in FIG. 3), and an operating voltage unit 90 (not explicitly illustrated in FIG. 3), the drive unit 80 comprising at least one excitation actuator 100 with a volume of excitation-active material, which excitation actuator, during operation, is supplied with electricity by the operating voltage unit 90 and is controlled or regulated by the electronics unit 200.

Expediently, the drive unit 80, the electronics unit 200 and the operating voltage unit 90 can be distributed in the housing 20 in such a way that a center of mass is in the region of the grip part 40. The user can handle the electric machine tool 10 safely and comfortably.

A housing-side operating part 30 is used for activation, by the user, of the tool 60 and/or of the electric machine tool 10. The operating part 30 can be, for example, a switch or a control switch or else comprise a plurality of operating elements, of which, for example, one can be provided for switching on the electric machine tool 10 and one can be provided for switching on and/or regulating the tool 60.

The drive unit 80, which comprises only one drive component formed by an excitation actuator 100, for example a piezoelectrically excited Langevin oscillator (also referred to as a piezoelectric actuator) with a volume of piezoelectrically active material 102, in the examples shown in FIG. 1 and FIG. 2, is arranged in the housing 20. When a high-frequency electrical voltage is applied, ultrasound is generated in a manner known per se, and this ultrasound is conducted, via a coupling element 106, for example a sonotrode, to the tool 60. The coupling element 106 can be a sonotrode, known per se. The length and the form as well as the material of the coupling element 106 determine the resonant frequency of the excitation actuator 100. The tool 60 can also influence the resonant frequency. In the variant embodiments in FIG. 1 and FIG. 2, the excitation actuator 100 is designed in such a way that the Langevin oscillator and the coupling element 106 are combined in one unit, and the total length thereof corresponds to approximately half the wavelength λ/2 of the ultrasonic oscillation. Other variant embodiments can envisage that the excitation actuator 100 comprises a plurality of components with the length λ/2. This may be: an oscillation generator, known as a converter, especially a Langevin oscillator, for example, amplitude transformation pieces 104 (known as boosters), possibly extension pieces, and the coupling element 106 (known as a sonotrode). The excitation actuator 100 can, however, also be in the form of a magnetoresistive actuator, in which the electrical resistance can be changed by applying an external magnetic field.

The volume of the piezoelectrically active material can be at least 0.2 cm³, preferably 0.5 cm³, in particular at least 1 cm³. Advantageously, a sufficient ultrasonic power can be achieved with a small physical size of the excitation actuator. The at least one excitation actuator 100 can have a power density of at least 5 watts/cm³, preferably of at least 20 watts/cm³, based on the volume of the piezoelectrically active material of the at least one excitation actuator 100. A correspondingly high power density is advantageous for a handheld compact electric machine tool 10 with dimensions which are as small as possible and manufacturing costs which are as low as possible.

The electronics unit 200 arranged in the housing 20 is used for applying at least control and/or regulation signals to the drive unit 80 and for supplying voltage to the excitation actuator 100. An operating voltage unit 90, in this case in the form of a battery or rechargeable battery pack with batteries or rechargeable batteries 92, is used for providing an electrical DC voltage for the electronics unit 90, which converts the operating voltage into a high-frequency voltage signal, with which the excitation actuator 100 is excited into oscillation, in a desirable manner.

The excitation actuator 100 can have, at the tool tip, an amplitude of at least 3 μm, preferably at least 8 μm, in particular at least 12 μm. A correspondingly high amplitude is advantageous for good power transmission to the workpiece and therefore for high working progress by means of the electric machine tool 10. An electrical power for application to the at least one excitation actuator can be at least 20 watts on the input side of the electronics unit 200. Advantageously, a sufficient power for an electric machine tool can thus be ensured. Conventional powers in the DIY sector are, for small cutting systems, approximately between 20 watts and 250 watts, preferably between 50 watts and 150 watts. For higher-power applications, for example drills, powers of above 50 watts to 1000 watts, preferably 200 watts to 500 watts, are required. In the professional workman sector, the power requirement for small systems is approximately between 50 and 400 watts, preferably 100 to 250 watts. In large systems, powers of from 200 W to 2000 watts, preferably 400 watts to 1000 watts, are used. Nevertheless, an electric machine tool 10 with manageable dimensions can be provided which can firstly be gripped or held by the hand of the worker and secondly provides sufficient power for machining. A maximum electrical excitation field strength of the at least one excitation actuator 100 can be in the range below 300 V/mm (based on the thickness, in particular disk thickness, of the piezo-electrically active material), preferably in the range of between 50 V/mm and 220 V/mm. Given a disk thickness of the excitation actuator 100 of typically from 1 mm to 10 mm, preferably 2 mm to 6 mm, in particular around 5 mm, the electrical voltages are below 1000 volts. This advantageously makes it possible to use the excitation actuator 100 in the handheld electric machine tool 10 with sufficient mechanical output power given advantageously small dimensions. The operating frequency of the at least one excitation actuator 100 can be in the range of between 10 kHz and 1000 kHz, preferably between 30 kHz and 50 kHz, in particular between 35 kHz and 45 kHz, particularly preferably around 40 kHz. As the frequency increases, the physical size of the components decreases and the mechanical loading of the oscillating system increases, with advantageous size ratios at a high output power and a favorable weight of the electric machine tool resulting in the selected frequency range.

An electrical output voltage of the operating voltage unit 90 in the case of supply with electrochemical stores can be in the range of from 3 volts to 100 volts DC, preferably in the range of from 3.5 volts to 40 volts, in particular 36 volts, 24 volts, 18 volts, 14.4 volts, 12 volts, 10.6 volts, 7.2 volts and 3.6 volts. Advantageously, battery packs or rechargeable battery packs can be used which are small and light enough to still ensure easy handling of the electric machine tool at a high output power. For non-mains operation, advantageously batteries on the basis of lithium-ions (Li-ion) or else nickel metal hydride (NiMeH), nickel cadmium (NiCd) can be used with a high power density and a relatively low weight. Alternatively, lead batteries or the like can also be used.

The respective electric machine tool 10 has an apparatus 300 for outputting an information signal, which can be output depending on at least one operational parameter of the electric machine tool 10. The apparatus 300 is designed to vary the frequency and/or amplitude of the information signal depending on a present operational parameter. The information signal is preferably output throughout the operation of the electric machine tool 10. This can take place continuously or else in pulsed fashion.

The electric machine tool 10 shown in FIG. 1 has, for example, an apparatus 300 with a loudspeaker 302, for example a piezoelectric loudspeaker, which outputs a tone signal which is pleasant for the user and has a low volume, for example a 440 Hz sinusoidal tone, during operation of the electric machine tool 10 in order to communicate the present operating state (for example on/off). The information signal can be varied in terms of its frequency and/or its volume, as a result of which the user can learn the presently required ultrasonic power during cutting, for example, without being distracted. The frequency can be lowered, for example in analogy to a pattern of noises of an electric machine tool operated by an electric motor, starting from an idling fundamental tone, as the machining power increases.

The electric machine tool 10 shown in FIG. 2 has, for example, an apparatus 300 with a vibration unit 304 in the grip part 40 and a light-emitting device 306 in the vicinity of the tool 60. In one embodiment, the light-emitting device 304 can be fitted, for example, in such a way that it directly illuminates the working tool 60. As a result, at the same time the illumination of the working area and status feedback to the user can take place without said user needing to take his eyes away from the actual machining process. For this purpose, the light-emitting device 304 can emit light forwards or can be fitted on the housing end side, for example.

During operation of the electric machine tool 10, a slight vibration of the grip part 40 with a low amplitude which can be felt by the user can take place in order to communicate the present operating state (for example on/off) without handling of the electric machine tool 10 being impaired. The information signal can be varied in terms of its frequency and/or its amplitude, as a result of which the user can learn, for example, the presently required ultrasonic power during drilling, without being distracted. The frequency can be lowered, for example in analogy to an electric machine tool operated by an electric motor, starting from an idling vibration with increasing machining power. At the same time, the light-emitting device 306 can, for example, illuminate in a first color, for example green, as long as the operational parameters are in their permissible ranges and in a second color, for example red, when one or more operational parameters has/have reached a critical value, for example operating temperature, battery capacity or the like.

The electric machine tool 10 shown in FIG. 3 has, for example, an apparatus 300 with a loudspeaker 302, for example a piezoelectric loudspeaker, which outputs a tone signal which is pleasant for the user and has a low volume, for example a 440 Hz sinusoidal tone, in order to communicate the present operating state (for example on/off), during operation of the electric machine tool 10 with ultrasound. The information signal can be varied in terms of its frequency and/or its volume, as a result of which the user can learn, for example, the presently required ultrasonic power during grinding, without being distracted. If the electric machine tool is only operated using the electric motor, the output of the information signal can be omitted.

FIG. 4 shows an exemplary embodiment of a circuit 400, which makes it possible to derive information on the presently required working power of the ultrasonic excitation actuator 100 from the operating current of the excitation actuator 100. A digital system controller 402 controls power electronics 404 of the electronics unit 200, which acts on the tool 60 or the excitation actuator 100. In this case, an operating current 410 flows to the excitation actuator 100.

A measurement signal 412 of the present exciter current amplitude can, after corresponding level matching in an operational amplifier 406, be passed on to the apparatus 300 via a voltage-controlled oscillator 408, said apparatus having a loudspeaker 302, for example. In a corresponding manner, this can naturally also take place with direct driving 414 of the apparatus 300 by means of the digital system controller 402.

In a further configuration, instead of the current, the excitation voltage or the directly determined or calculated operating power can be used as reference variable for the tone signal.

The circuit 400 illustrated by way of example is suitable not only for handheld electric machine tools, but also for ultrasonic stationary appliances, which comprise such an apparatus 300 for outputting an information signal, which can be output depending on at least one operational parameter of the ultrasonic stationary appliance, and the apparatus 300 being designed to vary the frequency and/or amplitude of the information signal depending on a present operational parameter.

1. An electric machine tool comprising:
a region with ultrasonic excitation for a tool which can be driven linearly and/or in oscillating fashion, with a drive unit for ultrasonic excitation:
an electronics unit for applying at least control and/or regulation signals to the drive unit; and
an operating voltage unit;
at least one ultrasonic excitation actuator of the drive unit, which, during operation, is supplied with electricity from the operating voltage unit and is subjected to control or regulation by the electronics unit; and
an apparatus for outputting an information signal, which can be output depending on at least one operational parameter of the electric machine tool,
wherein the apparatus is designed to vary frequency and/or amplitude of the information signal depending on one or more present operational parameters.

2. The electric machine tool as claimed in claim 1, wherein the apparatus is designed to reduce the frequency and/or the amplitude as the machining power increases.

3. The electric machine tool as claimed in claim 2, wherein the apparatus is designed to increase the frequency and/or the amplitude as the machining power increases.

4. The electric machine tool as claimed in claim 2, wherein the apparatus for changing the frequency and/or the amplitude is coupled to the operating voltage unit in such a way that the frequency and/or the amplitude can be set depending on the present operating current or on the present operating voltage.

5. The electric machine tool as claimed in claim 1, wherein a first component of the information signal can be linked to a first operational parameter, and a second component of the information signal can be linked to a second operational parameter.

6. The electric machine tool as claimed in claim 1, wherein the apparatus is designed to emit an alarm when a critical operational parameter is reached or exceeded.

7. The electric machine tool as claimed in claim 1, wherein the apparatus comprises a loudspeaker device.

8. The electric machine tool as claimed in claim 1, wherein the apparatus comprises a mechanical vibration unit, preferably in a grip region of the housing.

9. The electric machine tool as claimed in claim 1, wherein the apparatus comprises a luminaire unit.

10. The electric machine tool as claimed in claim 9, wherein the luminaire unit is provided for illuminating a working area.

11. An ultrasonic stationary appliance, comprising:
an apparatus for outputting an information signal, which can be output depending on at least one operational parameter of the ultrasonic stationary appliance, the apparatus being designed to vary the frequency and/or amplitude of the information signal depending on a present operational parameter.
